(19) United States
(12) Patent Application Publication
(10) Pub. No.: US 2006/0073466 A1
(43) Pub. Date: Apr. 6, 2006

(54) Glass dry-erase board

(76) Inventor: Benjamin Solomon, Incline Village, NV (US)

Correspondence Address: KLARQUIST SPARKMAN, LLP, 121 SW SALMON STREET, SUITE 1600, PORTLAND, OR, 97204, US

(21) Appl. No.: 10/919,566

(22) Filed: Aug. 17, 2004

(51) Int. Cl. B43L 1/00

(52) U.S. Cl. 434/408

(57) ABSTRACT

A glass dry-erase board. The glass dry-erase board has a smooth transparent glass writing surface. One embodiment utilizes tempered glass sheet, which provides the writing surface and has a non-specular and light blocking rear surface treatment and attached white plastic sheet on the back side of the glass sheet. The glass dry-erase board may include additional features such as wall mounts or one or more utensil trays.

### COPYRIGHT NOTICE

A portion of the disclosure of this patent document contains material which is subject to copyright protection. The copyright owner has no objection to the xerographic reproduction of the patent documents or the patent disclosure in exactly the form it appears in the U.S. Patent and Trademark Office file or records, but otherwise reserves all copyright rights whatsoever.

### FIELD OF THE INVENTION

The present invention relates to dry-erase boards. More particularly, the present invention relates to dry-erase boards with a glass writing surface.

### BACKGROUND

Chalk boards have long provided surfaces on which writing may be placed and erased, for subsequent re-writing on the surfaces of the boards. While effective, chalk boards require the use of chalk in order to write on them. Chalk, however, is typically messy, resulting in chalk dust on the writer's hands, on the board tray, and on the floor in the vicinity of the board. Chalk boards can also be difficult to read, because the contrast between the color of the chalk against the background provided by the chalkboard can be relatively weak. Chalk boards are also difficult to completely erase unless the user goes to the substantial effort of cleaning the board to remove the chalk residue.

One attempt to solve these types of problems with chalk boards has been provided by the dry-erase board. The dry-erase board typically has a writing side consisting of a hard opaque, white, and relatively smooth surface; dry-erase markers may be used to write on the surface. Although a dry-erase board can be significantly less messy while providing more writing surface contrast than a chalkboard, dry-erase boards are typically difficult to erase and clean. Over time, the white writing surface of the dry-erase board becomes colored by dry-erase markers used to write on the board; and when a permanent marker is used on the dry-erase board by accident, cleaning of the board can be difficult or even impossible.

Both chalkboards and dry-erase boards are typically relatively flexible and not readily utilized in an environment in which the boards should be relatively rigid and aesthetically attractive. Also, chalkboards and dry-erase boards usually cannot be utilized in an environment in which light must pass through or be emitted by the board, in order to provide a video or other translucent screen.

Mirrors with glass surfaces have been used to place writing, such as with a bar of soap, on their glass surfaces. Mirrors, however, typically have a specular (i.e., mirroring (image reflecting)) background material (often a metal layer) adjacent the back side of the glass, and this specular background material is distracting and otherwise generally ineffective for use as a background on which to write information, as in the case of classroom or business presentation.

References providing additional background information include: U.S. Pat. No. 2,303,120, to Greaves-Walker, entitled “Glass Chalkboard”; U.S. Pat. No. 2,264,244, to Lytle, entitled “Glass Blackboard”; U.S. Pat. No. 2,337,757, to Lewis, entitled “Compound Glass Sheet”; U.S. Pat. No. 3,846,011, to Steln, entitled “Chalkboard Useable as a Rear Projection Screen”; and U.S. Pat. No. 4,996,110, to Itsuo et al., entitled “White Board.”

### BRIEF SUMMARY OF ASPECTS OF THE INVENTION

Briefly stated, in one aspect the present invention provides a glass dry-erase board. The glass is translucent and provides contrast for dry-erase marking on the writing surface of the glass dry-erase board.

In one embodiment, the dry-erase glass board includes a glass section providing a writing surface on one side and a generally non-image-reflecting or non-specular, light blocking composition facing or adjacent the back side of the glass section or within the glass section. Preferably, the glass writing surface is relatively smooth, providing a hard surface that is relatively easy to write upon and clean.

The light blocking composition may include an opaque backing secured to the back side of the glass section by adhesive. In certain embodiments, the opaque backing may consist of a sheet, such as paper, cloth, or plastic sheet or tape, laminated to or otherwise abutting the back side of the glass.

In certain embodiments, the light blocking composition may include a frosting on or within the glass or other light blocking treatment of, or aspect of, the glass.

Most preferably, the dry-erase glass is transparent and tempered or otherwise treated or modified to enhance its strength or render it safer for use than untreated or unmodified glass. The dry-erase glass may be tinted if desired.

The glass dry-erase board may be mounted adjacent a wall, or it may provide a rigid table-top or other non-vertically extending rigid surface, which may also be used as a writing surface. The glass dry-erase board may also provide a projection or display screen such as, for example, for slide, television, movie, or computer projectors or displays.

It is to be understood that this is a brief summary of various aspects of the invention and/or various embodiments. Other aspects of the invention will become apparent as this specification proceeds. This brief summary is therefore neither exhaustive nor determinative of the scope of the present invention, and given embodiments need not include all features recited herein nor solve all issues or problems with the prior art noted above.

### BRIEF DESCRIPTION OF THE DRAWINGS

Preferred embodiments of the present invention are shown in the accompanying drawings in which:

FIG. 1 is a perspective view of a transparent. tempered glass dry-erase board mounted on a wall;

FIG. 2 is a cross-sectional view of the glass dry-erase board of FIG. 1;

FIG. 3 is an elevational view of a glass dry-erase board with an eraser equipment lip; and

FIG. 4 is a side plan view of the glass dry-erase board of FIG. 3.

### DETAILED DESCRIPTION OF PREFERRED EMBODIMENTS

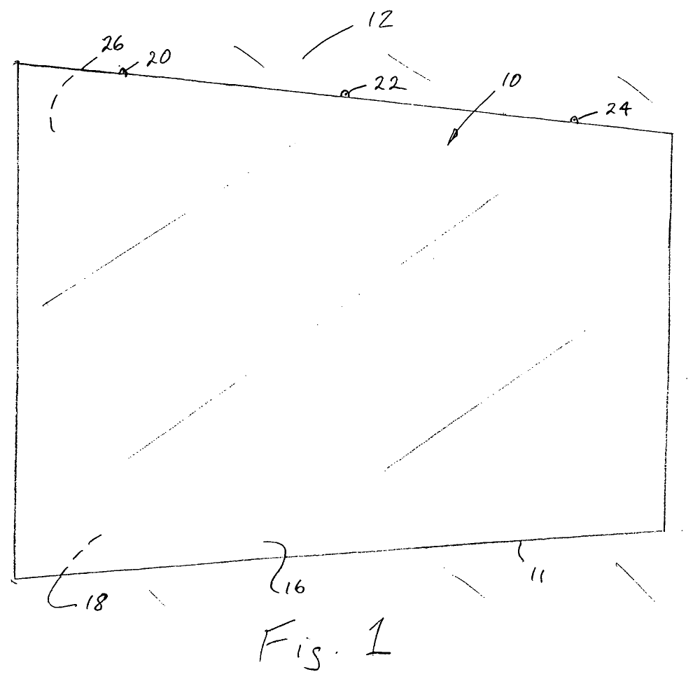

With reference now to FIG. 1, a dry-erase board, generally 10, is mounted on a wall 12. The dry-erase board 10 consists of 3/16 inch thick planar sheet 11 of tempered glass having a conventional smooth glass surface 16 on one side of the glass sheet and a frosted surface 18 on the opposite side of the glass sheet facing the wall 12. The smooth glass surface 16 provides a smooth, hard surface upon which a user may write indicia with, for example and among other things, a conventional dry-erase marker. The board 10 is hung on the wall 12 by three spaced hook or picture hangars 20, 22, 24 glued to the back side 26 of the dry-erase board 10 and hung on nails generally horizontally penetrating the wall 12.

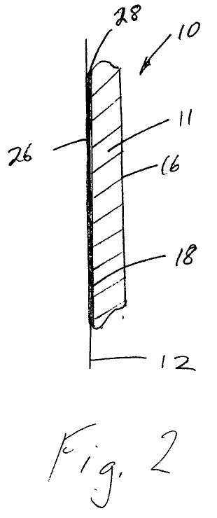

With reference to FIG. 2, the dry-erase board 10 has a layer of opaque white paint 28 painted on the frosted surface 18 opposite the smooth glass writing surface 16. The frosted surface 18 provides a roughened surface to which the paint layer 28 may adhere and also works in cooperation with the paint layer 28 to preferably provide a white background for the transparent writing surface 16. Alternatively, the paint layer 28 may also include, or consist entirely of, a light blocking sheeting, such as paper, plastic, or cloth sheeting for example, glued or otherwise adhered to the frosted surface 18 of the tempered glass sheet 11 in order to provide a non-image-reflecting or non-specular background and relatively sharp contrast background (e.g., white) for writing on the glass writing surface 16 with a contrasting colored material.

As shown in FIG. 2, the dry-erase board 10 can be mounted to the wall 12 so that the dry-erase board's back side 26 abuts and is flush with the planar, vertically extending wall surface 12. The tempered glass sheet may be made of clear glass to maximize transparency, but it may also be made of colored transparent glass, which may provide reduced transparency while providing, for example, enhanced aesthetic or architectural appearance.

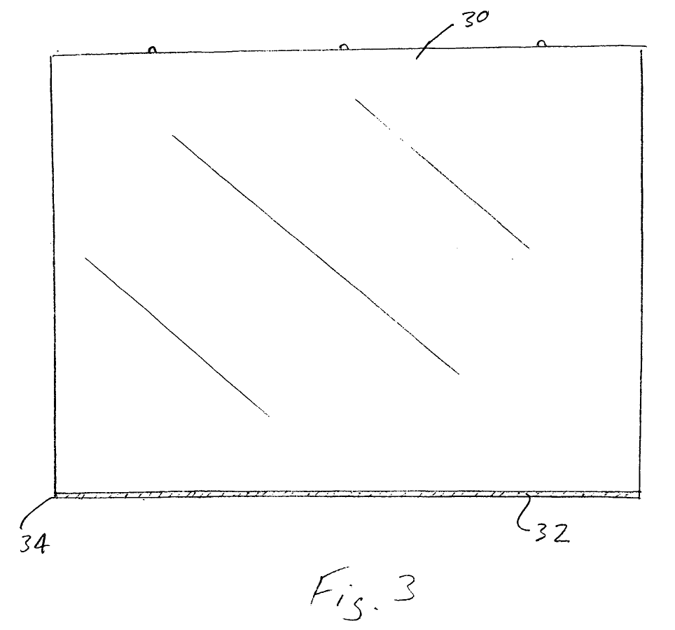

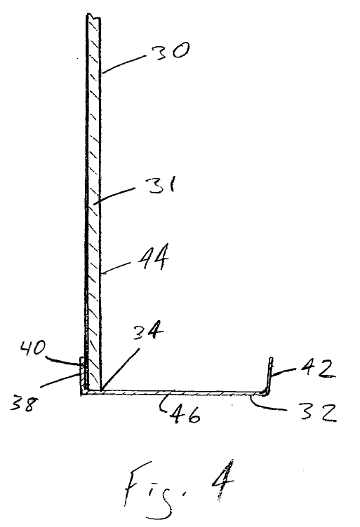

With reference now to FIG. 3, a glass dry-erase board 30 may have a marker or eraser metal or plastic tray 32 or other holder for presentation utensils. The tray 32 may extend along the lowermost edge 34 of the glass sheet 31 of the dry-erase board 30 (although a tray may be configured differently or mounted differently on the dry-erase board 30). In the embodiment of FIG. 4, the tray 32 has a somewhat U-shaped cross-sectional configuration 36, with one arm 38 secured (e.g., via adhesive) to the back side 40 of the glass dry-erase board 30, with the opposing arm or lip 42 extending upwardly but separated from the writing surface 44 of the glass dry-erase board 30, and with a planar tray element 46 extending laterally between the opposing arms 38, 40 and outwardly from the writing surface 44, while partially abutting the bottom or lowermost edge 34 of the glass sheet 31.

In certain embodiments such as those utilizing tempered glass, common “permanent markers” may be used to place indicia on the glass. Afterwards, the “permanent” markings may be relatively easily cleaned off the writing surface, including by use of solvents, including lacquer or paint thinner, without damage to the writing surface.

In this specification, the term “glass” means a translucent material that, when at room temperature, is in a generally amorphous, non-crystalline, state but with such a viscosity that the material is effectively solid. A preferred example is silica glass, most preferably of the type comprising silicon dioxide. Preferably, the glass is heat strengthened or, most preferably, fully tempered as well as transparent with a surface treatment on the back side, such as a white frosting on the surface. The preferred transparent glass thus is of the type commonly used to provide windows and see-through doors.

In the production of flat glass of a type useable in the embodiments described above the molten silica-based mix is cooled slowly under carefully controlled conditions. This procedure, called “annealing,” often removes undesirable stresses from the glass. Cooling occurs in an annealing “lehr”; hence, the glass is termed “annealed” or “ordinary” glass. Annealed glass that has been heated to a temperature near its softening point and cooled rapidly is described as “heat-treated glass.” The heat treating process produces highly desirable conditions of induced stress, which results in additional strength, resistance to thermal stress, and impact resistance.

Heat-treated glasses are classified as either fully tempered or heat strengthened. According to Federal Specification DD-G-1403B, fully tempered glass has a surface compression of 10,000 psi or more or an edge compression of 9,700 psi or more. Heat-strength glass must have a surface compression between 3,500 and 10,000 psi, or an edge compression between 5,500 and 9,700 psi. The fracture characteristics of heat-strengthened glass vary widely from very much like annealed glass near the 3,500 psi level to similar to fully tempered glass at the 10,000 psi level.

The “heat-treatment” process often involves application of a rapid air quench immediately upon withdrawal of hot (e.g., approximately 1200° F.) glass from the “tempering furnace.” The subsequent sustained application of an air quench produces the temper. As air direction against hot glass from arrays of fixed, reciprocating, or rotating blast nozzles, heat usually is extracted from both surfaces (uneven heat extraction may produce bow or warp) long enough to prevent reheating of the glass surfaces from the still-hot glass core. Chemical treatments may also be used to produce a similar result (temper) in glass.

Under wind pressure, tempered glass can be up to approximately four times as strong as annealed glass. Tempered glass typically resists breakage by small missiles traveling approximately twice as fast as missiles that break annealed glass. Tempered glass also is typically able to resist temperature differences (e.g., 200° F.-300° F.) that would cause annealed glass to crack. Exemplary characteristics of annealed and tempered glass are set forth in the following table:

| | Annealed | | Tempered | |
|---|---|---|---|---|
| | Glass | | Glass | |
| Typical Breaking Stress (large light | 6,000 | psi | 24,000 | psi |
| 60 sec. load) | | | | |
| Typical Impact Velocity Causing Fracture | 30 | ft/sec | 60 | ft/sec |
| (1/4″ light 5 gm missile, impact normal | | | | |
| to surface) | | | | |

It can thus be seen that embodiments described above can provide a dry-erase board that may be mounted to a wall or otherwise oriented, such as on a table or desk top, to provide a rigid, smooth, easily erased and cleaned dry-erase glass surface. Embodiments of the dry-erase board may also serve as a computer or projection screen for display of video and other images. The dry-erase board can be much easier to clean and maintain for use than conventional dry-erase boards, and it can be quite durable, particularly if made of tempered or other glass treated to enhance safety or strength of the glass.

It is to be understood that the foregoing is a detailed description of preferred embodiments. Variations and alterations may be made to the preferred and other embodiments while still falling within the scope of the present invention. The scope of the invention is therefore to be determined by the following claims as issued.

We claim:

1. A glass dry-erase board of the type useable to repeatedly write upon, erase the writing, and write upon again, the dry-erase board comprising in combination:
A. a translucent smooth glass writing surface; and
B. a non-specular, light blocking layer adjacent the glass writing surface;
whereby dry-erase marking may be marked on and erased from the translucent smooth glass writing surface.

2. The glass dry-erase board of claim 1 wherein the smooth glass writing surface comprises the front side of a glass sheet and the non-specular, light blocking layer comprises the opposing, back side of the glass sheet.

3. The glass dry-erase board of claim 2 wherein the opposing, back side of the glass sheet is frosted.

4. The glass dry-erase board of claim 2 wherein the non-specular, light blocking layer further comprises a light blocking paint abutting the opposing, back side of the glass sheet.

5. The glass dry-erase board of claim 3 wherein the non-specular, light blocking layer further comprises a light blocking paint abutting the opposing, black side of the glass sheets.

6. The glass dry-erase board of claim 2 wherein the non-specular, light blocking layer comprises a light blocking sheet secured by adhesive to opposing back side of the glass sheet.

7. The glass dry-erase board of claim 1 wherein the smooth glass writing surface comprises tempered glass.

8. The glass dry-erase board of claim 3 wherein the glass sheet comprises tempered glass.

9. The glass dry-erase board of claim 5 wherein the glass sheet comprises tempered glass.

10. The glass dry-erase board of claim 6 wherein the glass sheet comprises tempered glass.

11. The glass dry-erase board of claim 1 wherein the non-specular, light blocking layer includes a light reflective element facing the translucent smooth glass writing surface.

12. The glass dry-erase board of claim 4 wherein the light blocking paint includes a light reflective color abutting the back side of the glass sheet.

13. The glass dry-erase board of claim 6 wherein the light blocking sheet includes a light reflective surface abutting the back side of the sheet of glass.

14. The glass dry-erase board of claim 10 wherein the light blocking sheet includes a light reflective surface abutting the back side of the sheet of glass.

15. A glass dry-erase board assembly of the type useable to repeatedly write upon, erase the writing, and write upon again, the dry-erase board assembly comprising in combination:
A. a translucent glass sheet having a writing side and a back side, the writing side providing a substantial writing section on the glass sheet;
B. a non-specular, light blocking element secured to the back side of the translucent glass sheet and spanning the area of the substantial writing section on the glass sheet.

16. The glass dry-erase board of claim 15 wherein the writing section provides a smooth glass writing surface.

17. The glass dry-erase board of claim 15 further including at least one wall mount secured to dry-erase board, for mounting the glass dry-erase board to a wall with the back side abutting the wall.

18. The glass dry-erase board of claim 16 further including at least one wall mount secured to the dry-erase board, for mounting the glass dry-erase board to a wall with the back side abutting the wall.

19. The glass dry-erase board of claim 15 further including an eraser lip secured to the dry-erase board, the eraser lip extending laterally outwardly from the writing side of the glass sheet.

20. The glass dry-erase board of claim 16 further including an eraser lip secured to the dry-erase board, the eraser lip extending laterally outwardly from the writing side of the glass sheet.

21. The glass dry-erase board of claim 18 further including an eraser lip secured to the dry-erase board, the eraser lip extending laterally outwardly from the writing side of the glass sheet.

22. The glass dry-erase board of claim 17 wherein the non-specular, light blocking element includes a light reflecting portion secured to the back side of the translucent glass sheet.

23. The glass dry-erase board of claim 21 wherein the non-specular, light blocking element includes a light reflecting portion secured to the back side of the translucent glass sheet.

24. A method of generating erasable writing, the method comprising the steps of:
A. providing a translucent glass sheet with a smooth glass surface and a non-specular, light blocking section adjacent the smooth glass surface;
B. writing indicia on the smooth glass surface with a dry-erase marker; and
C. erasing the indicia on the smooth glass surface with a dry-erase eraser.

25. The erasable writing method of claim 24 also including the step of placing indicia on the smooth glass surface with a permanent ink marker.

26. The erasable writing method of claim 24 also including the step of projecting an illuminated image on the smooth glass sheet with an illuminating image projector.

27. The erasable writing method of claim 24 wherein the glass sheet comprises tempered glass and the non-specular, light blocking section includes a light reflective layer abutting the glass sheet.

28. The erasable writing method of claim 26 wherein the glass sheet comprises tempered glass and the non-specular, light blocking section includes a light reflective layer abutting the glass sheet.
